(19) United States
(12) Patent Application Publication
(10) Pub. No.: US 2013/0055142 A1
(43) Pub. Date: Feb. 28, 2013

(54) ELECTRONIC DEVICE WITH TOUCH SCREEN DEVICE, METHOD OF MOVING FUNCTION ICON AND COMPUTER READABLE STORAGE MEDIA COMPRISING COMPUTER EXECUTABLE INSTRUCTIONS

(71) Applicant: XIAO-GUANG LI, Shenzhen City (CN)

(72) Inventor: XIAO-GUANG LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/335,963

(22) Filed: Dec. 23, 2011

(30) Foreign Application Priority Data
Aug. 25, 2011 (CN) 201110246447.3

(51) Int. Cl. G06F 3/048

(52) U.S. Cl. 715/777

(57) ABSTRACT

An electronic device is disclosed. The electronic device includes a display module, an icon sensing module, an icon moving module, a folder sensing module, and an icon adding module. The display module displays icons and a number of folder tab buttons associated with folders respectively. The icon sensing module senses a touch on an icon. The icon moving module actuates the icon into a movable state if the touch on the icon is an icon move operation. The folder sensing module senses if the touch on the selected icon is moved onto a folder tab button. The icon adding module adds the icon to the folder associated with the folder tab button. A method of moving icons and one or more computer readable storage media are also disclosed.

### BACKGROUND

1. Technical Field

The present disclosure relates to an electronic device with a touch screen device, a method of moving function icons and one or more computer readable storage media comprising computer executable instructions.

2. Description of Related Art

Electronic devices typically include many icons representing application programs. A user manages the icons via file folders. Generally, the icons and file folders cannot be wholly displayed on one page because of the limited display area of the electronic device, thus the icon and the file folder which the icon belongs to should be displayed on different pages. When there is a need to move the icon from a current page to another page where the file folder is disposed, the user has to drag the icon across one page or several pages, which is inconvenient.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a schematic view of an electronic device, according to an exemplary embodiment.

FIG. 2 is a block diagram of the electronic device of FIG. 1.

FIG. 3 is a flowchart of a method of moving icons of the electronic device of FIG. 1, according to an embodiment.

### DETAILED DESCRIPTION

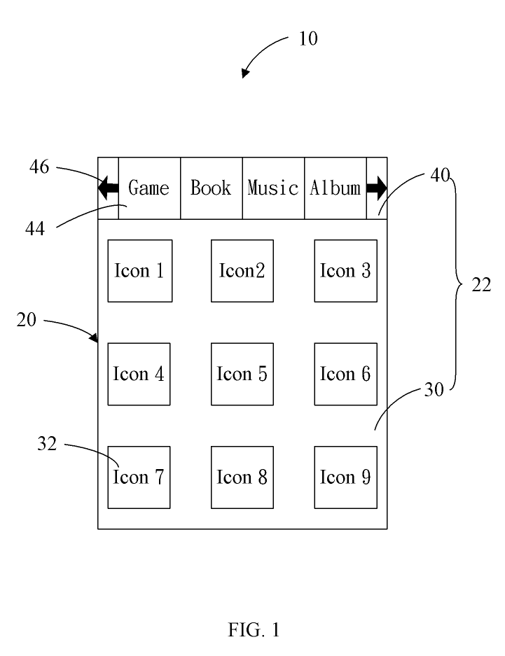

Referring to FIG. 1, an electronic device 10 according to an exemplary embodiment includes a touch screen device 20. The electronic device 10 entries to an icon management state as long as the electronic device 10 is booted up. In an alternative exemplary embodiment, the electronic device 10 entries to the icon management state by a menu or a shortcut key. In the icon management state, the touch screen device 20 displays a folder interface 22. The folder interface 22 displays an icon area 30 and a folder tab button area 40. The icon area 30 includes icons 32 associated with application programs. The folder tab button area 40 includes a number of folder tab buttons 44, such as a game folder button, a book folder button, a music folder button, an album folder button, and two arrow bars 46 respectively disposed on opposite ends of the folder tab button area 40. The folder tab buttons 44 are associated with a plurality of folders respectively. Each folder stores a type of icons 32 added therein by a user. When a selected tab button 44 is opened, the icons 32 in the folder associated with the folder tab button 44 are displayed.

When the user manages the icons 32, an icon 32 is moved to a folder tab button 44 displayed on the folder tab button area 40, the selected icon 32 is added into the folder tab button 44. If all the folder tab buttons 44 cannot be displayed on the folder list area 40, the user can click on the arrow bars 46, in response, the folder moving module 60 moves the folder tab buttons 44 along the arrowhead direction of the selected arrow bars 60 until a desired folder tab button 44 is displayed on the folder tab button area 40 and the user stops clicking or moves away from the arrow bars 46. When a selected folder tab button 44 is opened, the icons 32 in the folder associated with the selected folder tab button 44 are displayed.

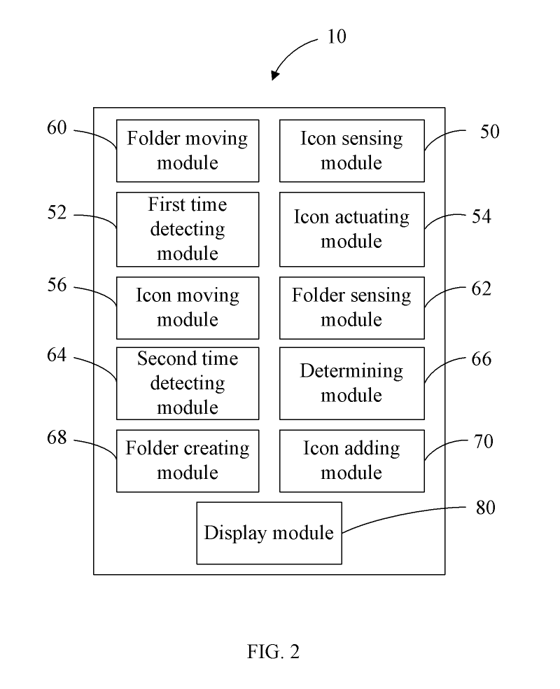

Referring to FIG. 2, the electronic device 10 includes a display module 80, a folder moving module 60, an icon sensing module 50, a first time detecting module 52, an icon actuating module 54, an icon moving module 56, a folder sensing module 62, a second time detecting module 64, a determining module 66, a folder creating module 68 and an icon adding module 70.

The display module 80 displays the icons 32 on the icon area 30 and the folder tab buttons 44 on the folder tab button area 40 on the folder interface 22 when the electronic device 10 enters the icon management state. The icon sensing module 50 senses a touch on one of the icons 32 by a user. If the touch on the selected icon 32 meets a first condition, the icon moving module 56 determines that the touch on the selected icon 32 is an icon move operation, and actuates the selected icon 32 into a movable state and further moves the selected icon 32 following a drag operation on the folder interface 22. The folder sensing module 62 senses whether the touch on the selected icon 32 is moved to one of the folders 44. If the folder sensing module 62 senses a touch on a folder tab button 44 and the touch on the folder tab button 44 meets a second condition, the icon adding module 70 adds the icon 32 to the folder associated with the touched folder tab button 44.

The folder moving module 60 moves the folder tab buttons 44 displayed on the folder tab button area 40 in response to clicks on the arrow bars 46 by a user until a desired folder tab button 44 is displayed on the folder tab button area 40.

If the icon sensing module 50 senses a touch on an icon 32. The first time detecting module 52 detects a time period of the touch on the icon 32 and determines whether the time period on the icon 32 is equal to or longer than a first preset time period. If the time period on the icon 32 is shorter than the first preset time period, the icon actuating module 54 determines that the touch on the icon 32 is an icon click operation, and actuates the application program which the icon 32 associated with. If the time period on the function icon 32 is equal to or longer than the first preset time period, the icon moving module 56 determines that the touch on the icon 32 is an icon move operation, and actuates the icon 32 into a movable state and further moves the icon 32 following a drag operation on the folder interface 22.

The folder sensing module 62 senses whether the touch on the icon 32 is moved onto one of the folder tab buttons 44. The folder sensing module 62 senses a touch on the icon 32, when the touch on the icon 32 is moved onto one of the folder tab buttons 44. Then the second time detecting module 62 detects a time period of the touch on the folder tab button 44 and determines whether the time period is equal to or longer than a second preset time period. If the time period on the folder tab button 44 is equal to or longer than the second preset time period, the determining module 66 determines whether the number of the icons in the folder associated with the folder tab button 44 is less than a preset number. If the number of the icons in the folder associated with the folder tab button 44 is less than the preset number, the icon adding module 70 adds the icon 32 to the folder associated with the folder tab button 44. If the number of the icons in the folder associated with the folder tab button 44 is greater than a preset number, the folder creating module 68 creates a new folder tab button 44′ associated with the folder tab button 44. In the exemplary embodiment, the folder tab button 44′ and 44 are associated with each other by their names. For example, the name of the folder tab button 44 is game, and the name of the folder tab button 44′ is game 2. The new folder tab button 44′ is positioned adjacent to the folder tab button 44. When the new folder tab button 44′ is created, the icon adding module 70 adds the icon 32 to the new folder associated with the folder tab button 44′. In an alternative exemplary embodiment, the number of the icons 32 in the folder associated with the folder tab button 44 is not limited, the icon adding module 70 adds the icon 32 to the folder associated with the folder tab button 44 as long as the time period on the folder tab button 44 is equal to or longer than the second preset time period. If the time period on the folder tab button 44 is less than the second preset time period, the icon 32 is not added to the folder associated with the folder tab button 44.

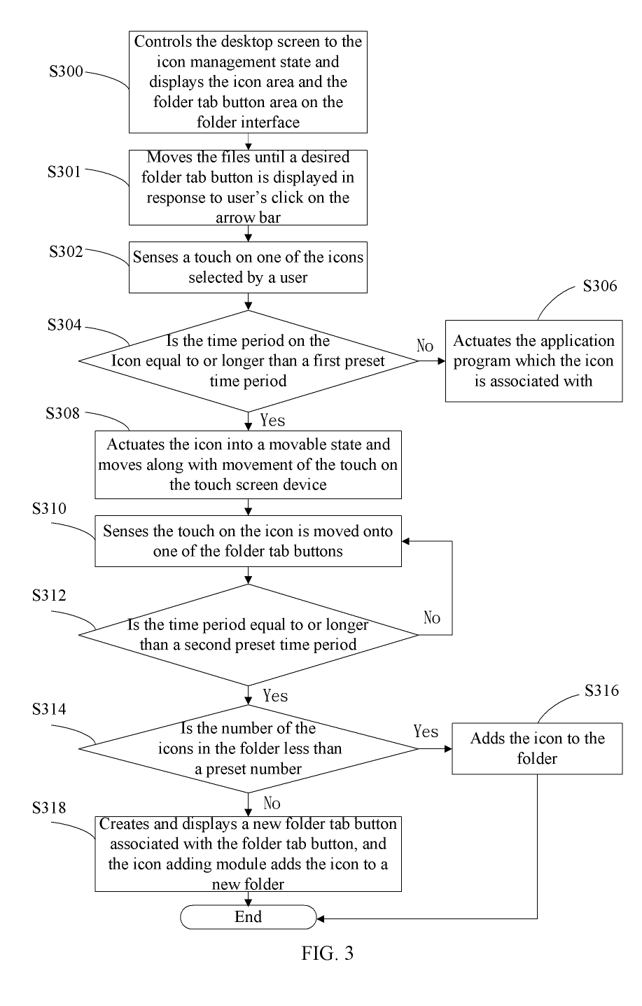

Referring to FIG. 3, a flowchart of a method of moving a function icon 32 of the electronic device 10 is provided.

In step S300, the display module 80 controls the folder interface 22 of the electronic device 10 with the touch screen device 20 to the icon management state in response to a user operation and displays the icon area 30 and the folder tab button area 40 on the folder interface 22.

In step S301, the folder moving module 60 moves the folder tab buttons 44 along the arrowhead direction of the selected arrow bars 60 until a desired folder tab button 44 is displayed on the folder tab button area 40 in response to user's click on the arrow bar 46.

In step S302, the icon sensing module 50 senses a touch on one of the icons 32 selected by a user.

In step S304, the first time detecting module 52 detects a time period of the touch on the icon 32 and determines whether the time period on the icon 32 is equal to or longer than a first preset time period. If the time period on the icon 32 is equal to or longer than the first preset time period, the procedure goes to step S308, otherwise the procedure goes to step S306.

In step S306, the icon actuating module 54 determines that the touch on the icon 32 is an icon click operation, and actuates the application program which the icon 32 is associated with.

In step S308, the icon moving module 56 determines that the touch on the icon 32 is an icon move operation, and actuates the icon 32 into a movable state and moves along with movement of the touch on the touch screen device 20.

In step S310, the folder sensing module 62 senses the touch on the icon 32 is moved onto one of the folder tab buttons 44.

In step S312, the second time detecting module 62 detects a time period of the touch on the folder tab button 44 and determines whether the time period is equal to or longer than a second preset time period. If the time period on the folder tab button 44 is equal to or longer than the second preset time period, the procedure goes to S314, otherwise the procedure goes to S310.

In step S314, the determining module 66 determines whether the number of the icons in the folder associated with the folder tab button 44 is less than a preset number. If the number of the icons in the folder associated with the folder tab button 44 is less than a preset number, the procedure goes to S316, otherwise the procedure goes to S318.

In step S316, the icon adding module 70 adds the icon 32 to the folder associated with the folder tab button 44.

In step S318, the folder creating module 68 creates and displays a new folder tab button 44′ associated with the folder tab button 44, and the icon adding module 70 adds the icon 32 to a new folder associated with the folder tab button 44′. In the exemplary embodiment, the name of the folder tab button 44′ matches that of the folder tab button 44. For example, the name of the folder tab button 44 is game, the name of the folder tab button 44′ is game 2. The new folder tab button 44′ is positioned adjacent to the folder tab button 44.

It is to be understood, however, that even though numerous characteristics and advantages of the present disclosure have been set fourth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An electronic device, comprising:
a touch screen device configured to display a folder interface, the folder interface comprising an icon area and a folder tab button area;
a display module configured to display a plurality of icons associated with application programs on the icon area and display a plurality of folder tab buttons on the folder tab button area, the folder tab buttons associated with a plurality of folders;
an icon sensing module configured to sense a touch on a selected one of the icons by a user;
an icon moving module configured to actuate the icon into a movable state if the touch on the selected icon is determined as an icon move operation;
a folder sensing module configured to sense if the touch on the selected icon is moved onto a selected one of the folder tab button; and
an icon adding module configured to add the selected icon to the folder associated with the selected one of the folder tab buttons if the touch on the selected folder tab button meets a preset condition.

2. The electronic device as described in claim 1, further comprising a time detecting module, wherein the time detecting module is configured to detect a time period of the touch on the selected icon, if the time period on the selected icon is equal to or longer than a preset time period, the touch on the selected icon is determined as an icon move operation.

3. The electronic device as described in claim 1, further comprising a time detecting module, wherein the time detecting module is configured to detect a time period of the touch on the selected folder tab button, if the time period on the selected folder tab button is equal to or longer than a preset time period, the touch on the selected folder tab button meets the preset condition.

4. The electronic device as described in claim 1, further comprising a determining module and a folder creating module, the determining module is configured to determine if the number of the icons in the folder is less than a preset number, the touch on the selected folder tab button is determined that it meets the preset condition if the number of the icons in the folder is less than the preset number, if the number of the icons in the folder is greater than the preset number, the folder creating module creates and displays a new folder tab button associated with the selected folder tab button and the icon adding module adds the selected icon to a new folder associated with the new folder tab button.

5. The electronic device as described in claim 1, further comprising a folder moving module, the folder tab button area further comprises two arrow bars respectively disposed on opposite ends of the folder tab button area, the moving module is configured to move the folder tab button in response to clicks by a user on the arrow bars.

6. A method of moving icons of an electronic device, the electronic device comprises a touch screen device configured to display a folder interface, the method comprising:
displaying an icon area and an folder tab button area on the folder interface, the icon area comprising a plurality of icons, the folder tab button area listing a plurality of folder tab buttons associated with a plurality of folders respectively;
sensing a touch on an icon selected by a user;
actuating the icon into a movable state if the touch on the selected icon is determined as an icon move operation;
sensing if the touch on the selected icon is moved onto a selected one of folder tab buttons; and
adding the selected icon to the folder associated with the selected folder tab button if the touch on the selected folder tab button meets a preset condition.

7. The method of moving icons as described in claim 6, further comprising:
detecting a time period of the touch on the selected icon, wherein the touch on the selected icon is determined as an icon move operation if the time period on the selected icon is equal to or longer than a preset time period.

8. The method of moving icons as described in claim 6, further comprising:
detecting a time period of the touch on the selected folder tab button, wherein the touch on the selected folder tab button meets the preset condition if the time period on the selected folder tab button is equal to or longer than a preset time period.

9. The method of moving icons as described in claim 6, further comprising:
determining if the number of the icons in the folder is less than a preset number, the touch on the selected folder tab button is determined that it meets the preset condition if the number of the icons in the folder is less than the preset number; and
creating and displaying a new folder tab button associated with the selected folder and adding the selected icon to a new folder associated with the new folder tab button if the number of the icons in the folder is greater than the preset number.

10. The method of moving icons as described in claim 6, wherein the folder interface includes an arrow bar on the folder tab button area, the method further comprising:
moving the folder tab buttons displayed on the folder tab button area in response to clicks by a user on the arrow bar.

11. One or more computer readable storage media comprising computer executable instructions to be executed in electronic device with a touch screen device, the touch screen device configured to display a folder interface, the instructions, when executed, implement a method comprising:
displaying an icon area comprising a plurality of icons and an folder tab button area listing a plurality of folder tab buttons associated with a plurality of folders respectively on the folder interface;
sensing a touch on an icon selected by a user;
actuating the icon into a movable state if the touch on the selected icon is determined as an icon move operation;
sensing if the touch on the selected icon is moved onto a selected one of folder tab buttons; and
adding the selected icon to the folder associated with the selected folder tab button if the touch on the selected folder tab button meets a preset condition.

12. The computer readable storage media as described in claim 11, wherein the method further comprises:
detecting a time period of the touch on the selected icon, wherein the touch on the selected icon is determined as an icon move operation if the time period on the selected icon is equal to or longer than a preset time period.

13. The computer readable storage media as described in claim 11, wherein the method further comprises:
detecting a time period of the touch on the selected folder tab button, wherein the touch on the selected folder tab button meets the preset condition if the time period on the selected folder tab button is equal to or longer than a preset time period.

14. The computer readable storage media as described in claim 11, wherein the method further comprises:
determining if the number of the icons in the folder is less than a preset number, the touch on the selected folder tab button is determined that it meets the preset condition if the number of the icons in the folder is less than the preset number; and
creating and displaying a new folder tab button associated with the selected folder and adding the selected icon to a new folder associated with the new folder tab button if the number of the icons in the folder is greater than the preset number.

15. The computer readable storage media as described in claim 11, wherein the folder interface includes an arrow bar on the folder tab button area, the method further comprising:
moving the folder tab buttons displayed on the folder tab button area in response to clicks by a user on a arrow bar on the folder tab button area.
